(19) United States
(12) Patent Application Publication
(10) Pub. No.: US 2026/0309644 A1
(43) Pub. Date: Oct. 8, 2026

(54) INSPECTION SYSTEMS, DEVICES, AND METHODS USING POLARIZED LIGHT

(71) Applicant: General Electric Company, Evendale, OH (US)

(72) Inventors: Uday Singh, Niskayuna, NY (US); Debasish Mishra, Bengaluru (IN); Vamshi Krishna Reddy Kommareddy, Hyderabad (IN); Jessen Compagnat, Saint-Denis-de-Brompton (CA)

(21) Appl. No.: 19/173,516

(22) Filed: Apr. 8, 2025

(51) Int. Cl. G01N 21/95; G01N 21/88; G06T 7/00

(52) U.S. Cl. CPC G01N 21/951; G06T 7/0004; G01N 2021/8848; G06T 2207/20081

(57) ABSTRACT

In some embodiments, an inspection system includes an illumination apparatus configured to illuminate a component with polarized light. The illumination apparatus includes a light source and a polarizer. The inspection system also includes an image acquisition apparatus that includes an optical sensor and an analyzer. The optical sensor is configured to detect light reflected or scattered from the component. The analyzer may have a polarization axis oriented to limit polarized light reflected from the component via specular reflection. The inspection system may also include a controller in communication with the optical sensor, the controller configured to: receive optical data indicative of non-polarized light reflected or scattered from the component from the optical sensor; and identify at least one defect on the component based on the optical data.

### TECHNICAL FIELD

These teachings relate generally to systems and methods for inspecting industrial components and, in particular, systems and methods for inspecting bearing components such as ceramic balls.

### BACKGROUND

Various machine assemblies (such as turbine engines used in aircraft) are utilized in vehicular and industrial applications. These assemblies include different types of components, which are regularly inspected to ensure proper performance of the assemblies. During an inspection, the machine assembly may be transported to a service shop, wherein the machine assembly is disassembled into its component parts. Examples of components that are inspected include bearing assembly components, for instance, metal or ceramic balls or rollers.

### BRIEF DESCRIPTION OF DRAWINGS

Various needs are at least partially met through provision of the inspection devices and methods using polarized light described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a schematic diagram of an inspection system that uses polarized light, in accordance with various embodiments of these teachings;

FIG. 2 is a schematic diagram of an inspection device that uses polarized light, in accordance with various embodiments of these teachings;

FIG. 3 is a schematic diagram of a defect on the surface of a component, according to some embodiments;

FIG. 4 is a schematic diagram of components of the controller of FIG. 1, according to some embodiments;

FIG. 5 is a block diagram of an inspection method that can be performed using a polarized imaging inspection station, in accordance with various embodiments of these teachings;

FIG. 6 is a flow diagram of an inspection method using polarized light, in accordance with various embodiments of these teachings; and

FIGS. 7A, 7B, and 7C are images of a defect using various inspection techniques.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

One example application for bearings is in a gearbox of an aircraft engine. Bearings can be made from ceramic materials that have polished surfaces. Ceramic bearings used in aerospace applications may have tight requirements on defects, such as C-cracks or spallation, present on the bearing. Due to the non-conductive nature of ceramic components such as bearings, eddy current inspection is not possible for defect detection. Thus, inspection for defects such as cracks present on ceramic bearings typically involves fluorescent penetrant inspection (FPI). The FPI process is tightly controlled and adds significant processing time beyond the manual inspection time. For example, FPI involves applying a pigment to a bearing and exposing the pigment to ultraviolet (UV) light for a few hours.

The approaches described herein use polarized light to detect defects such as cracks present on components, such as ceramic bearings. Ceramic bearings and other industrial components have polished surfaces. Such polished surfaces are highly reflective. Thus, when a ceramic bearing is illuminated with polarized light, when the polarized light is reflected from the polished surface of the ceramic bearing, the polarization is preserved. However, when a defect is present on the surface of a ceramic bearing, the polarized light scatters from the surface and the polarization is changed. The inspection systems and methods described herein illuminate the surface of a component such as a ceramic bearing with polarized light and use an analyzer in combination with an optical sensor. The analyzer is configured to block specular reflection where polarization is preserved so that only the scattered light that is non-polarized is received by the optical sensor. In this manner, the optical sensor senses a region on the component where a defect, such as a crack, is present.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

It is additionally noted that the term “substantially” is also utilized herein to represent an inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

As used herein, the terms “first”, “second”, and “third” may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

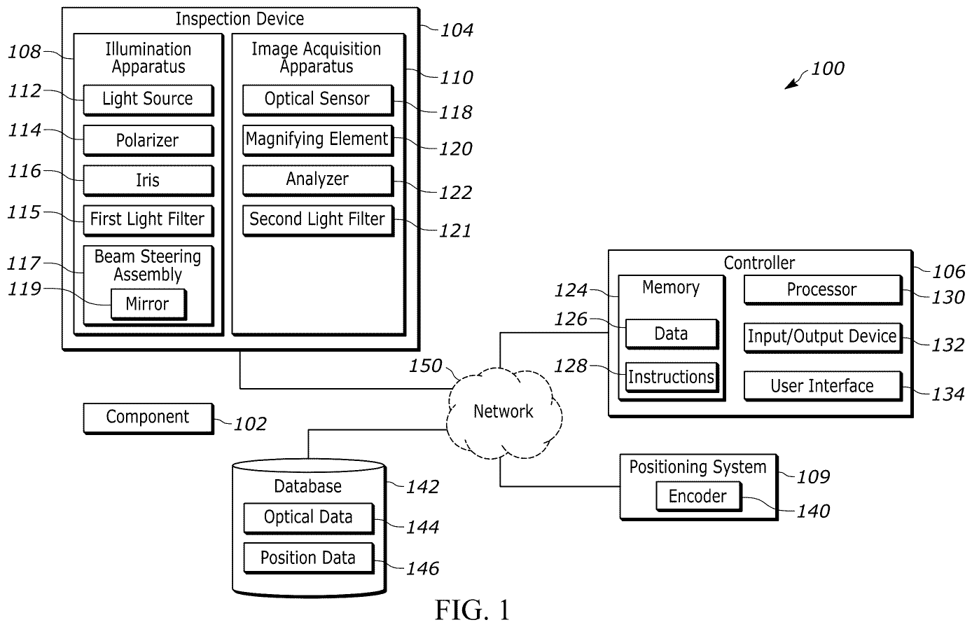

Turning to the figures, FIG. 1 shows an inspection system 100 according to some embodiments. The inspection system 100 illuminates a component, such as a component 102, with polarized light and images of the component 102 are acquired. The images can then be analyzed to detect or identify defects, such as cracks, in the component 102. The component 102 may have a polished or mirror-like surface such that polarized light illuminating the surface of the component 102 undergoes specular reflection that preserves the polarization of the light. Polished surfaces may refer to surfaces having a surface roughness in the range of about 0.1 micrometers (μm) to about 1 μm or, in some aspects, in the range of about 0.2 μm to about 0.5 μm. A polished surface has a surface roughness in the order of the surface roughness of a ceramic material. In other aspects, a polished surface has a surface roughness that is within about 2 to 3 orders of magnitude of the surface roughness of a ceramic material (e.g., within 2 to 3 orders of about 0.2 μm to about 0.5 μm). In some embodiments, the component 102 is a bearing (e.g., a ball bearing). In some embodiments, the component 102 is made from a ceramic material.

The inspection system 100 includes an inspection device 104 in communication with a controller 106. The inspection device 104 includes an illumination apparatus 108 and an image acquisition apparatus 110. In some embodiments, the inspection system 100 also includes a positioning system 109 for moving the component 102 relative to the inspection device 104 during an inspection.

The illumination apparatus 108 is configured or arranged to illuminate at least a portion of the component 102 with polarized light. For example, the illumination apparatus 108 is positioned adjacent to the surface of the component 102, for example, above the component 102. In general, the illumination apparatus 108 includes a light source 112 and a polarizer 114.

The light source 112 can be any suitable light source. Suitable light sources include but are not limited to lasers, light emitting diodes (LEDs), light bulbs, etc. In some embodiments, the light source 112 is a collimated light source that emits parallel rays of light. The light source 112 can be a single spectral, a multispectral, or a hyperspectral light source. A single spectral light source can emit light at a single wavelength or wavelength range, for example, to emit light of a single color. A multispectral light source can emit light across multiple wavelengths or wavelength ranges, for example, to emit light of multiple colors. A hyperspectral light source can emit a continuous spectrum of wavelengths across a broad range. Using a multispectral light source can capture information from various parts of the light spectrum to provide more detailed information about the component 102 being inspected. Use of multispectral light can result in a higher confidence in the detection of defects, characteristics, or features of the component 102. For example, use of multispectral light allows defect detection in multiple colors, which improves defect detection and detection confidence. In some embodiments, the light source 112 emits light at a wavelength that is within about 1 to 5 wavelengths or, in some aspects, about 2 to 3 wavelengths of the surface roughness of the component 102 being inspected. The type of defect that is visible during an inspection using the inspection device 104 depends on the wavelength(s) of light used to illuminate the component 102.

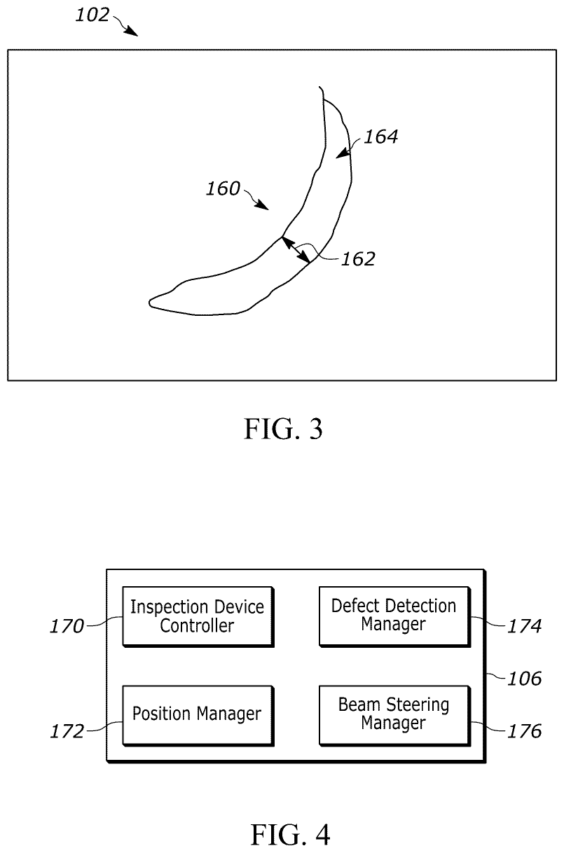

The type of defect that is visible on the component 102 being inspected using the inspection device 104 depends on the wavelength (e.g., the color) of light emitted from the light source 112. In addition, the size of defect that is visible on the component 102 being inspected using the inspection device 104 depends on the wavelength (e.g., the color) of light emitted from the light source 112. In some examples, the wavelength of light emitted from the light source 112 is less than or about the same size as a defect gap associated with a defect to be detected on the component 102 (e.g., the defect trying to be observed). The term defect gap may refer to a dimension of a gap or opening in a defect that is present on the component 102. In one example, when the defect is a crack, the defect gap is a width of the crack. An example defect gap 162 is shown in FIG. 3. When the light source 112 is a multispectral light source, wavelengths may be selected to detect a range of defect sizes.

In some examples, the wavelength of light emitted from the light source 112 is selected such that the light is a different color from the component 102 that is being inspected. In this manner, light emitted from the light source 112 will be reflected rather than absorbed by the component 102. For example, if the component 102 is red, the light source 112 is selected such that it does not emit red light.

The polarizer 114 is configured to change a polarization state of light from the light source 112. In particular, the polarizer 114 is configured to polarize light from the light source 112. The polarizer 114 allows light waves of a specific polarization to pass through while blocking light at other polarizations. In some configurations, the polarizer 114 has an axis of polarization. Components of light waves entering the polarizer 114 that are parallel to the axis of polarization are allowed to pass through the polarizer 114, while other non-parallel components of the light waves are blocked. Any type of polarizer that works under a given optical spectrum can be used in the illumination apparatus 108. In some examples, the polarizer 114 has an extinction ratio of about 100 or greater

In some embodiments, the illumination apparatus 108 also includes an iris 116. The iris 116 is configured to control or adjust an amount of light passing from the light source 112 to the component 102 and, ultimately, to an optical sensor 118 (e.g., via reflection or scattering from the component 102). Narrowing a view of the optical sensor 118 via the iris 116 allows the inspection device 104 to focus on areas of interest on the component 102. In addition, narrowing a view of the optical sensor 118 via the iris 116 reduces saturation in images acquired by the optical sensor 118. The iris 116 is configured control the amount of light entering the optical sensor 118, for example, to control the view of the optical sensor 118. In some configurations, the iris 116 is disposed between the polarizer 114 and the light source 112. In other configurations, the iris 116 is disposed between the polarizer 114 and the component 102. The iris 116 can comprise an adjustable aperture to control an amount of light reaching the component 102. A wider aperture allows more light to reach the component 102 and be reflected or scattered back to the optical sensor 118 while a narrower aperture allows less light to reach the component 102 and the optical sensor 118.

In some embodiments, the illumination apparatus 108 also includes a first light filter 115 that is configured to block, reflect, or absorb unwanted light to eliminate unwanted signatures in optical data (e.g., images) acquired by the inspection device 104. For example, the first light filter 115 may block, reflect, or absorb unwanted wavelengths of light. The first light filter 115 can be any suitable light filter including but not limited to a spectral filter, a band pass filter, a short pass, or long pass filter.

In some embodiments, the illumination apparatus 108 also includes a beam steering assembly 117 for redirecting light from the light source 112. The beam steering assembly 117 can be used to redirect light from the illumination apparatus 108 when inspecting hard to reach locations or components where access is restricted. The beam steering assembly 117 can include a mirror 119 for redirecting light from the light source 112. The mirror 119 can be used to control the path of light from the light source 112. The mirror 119 can be disposed at any suitable position between the light source 112 and the component 102. In some embodiments, the mirror 119 is coupled to a galvanometer actuator for adjusting the position of the mirror 119 and thereby the path of light from the light source 112. In some aspects, the galvanometer actuator is configured to adjust an incident angle of the light relative to the component 102. Rotation of the mirror 119 can allow the illumination apparatus 108 to direct light to reach confined spaces or difficult to access components.

In some alternative embodiments the illumination apparatus 108 includes an apparatus configured to generate ultrasonic (UT) waves. Such an apparatus may include a UT source in addition to or in place of the light source 112. When UT waves interact with a crack on the component 102 and a light illuminates the component 102, it is possible to observe how UT waves are propagating via light. For example, it is possible to observe how UT waves are transmitted or reflected across the component 102. In yet other embodiments, the illumination apparatus 108 uses birefringence to increase polarization interaction at the defect.

The image acquisition apparatus 110 is configured to acquire images or other optical data of the component 102, for example, while the component 102 is illuminated with polarized light from the illumination apparatus 108. For example, the image acquisition apparatus 110 is positioned adjacent to the surface of the component 102, for example, above the component 102. The image acquisition apparatus 110 includes the optical sensor 118 and an analyzer 122.

The optical sensor 118 can be any suitable optical sensor. In some embodiments, the optical sensor 118 is a camera. The optical sensor 118 can be a monochrome camera or a red, green, and blue light (RGB) camera. In some embodiments, the optical sensor 118 is a hyper spectral sensor. The hyper spectral sensor may be configured for wavelength change detect, bandwidth change detection, or both. The optical sensor 118 can have an in-built polarization sensor, for example, that is configured to measure the degree of polarization, the direction of polarized light, or both. The in-built polarization sensor can capture all possible polarization states, which later can be used to detect a polarization level of the light. The polarization level on various regions of the component 102 can indicate where defects such as cracks are present. For example, for a crack, the polarization level will be low (e.g., close to zero) and for a specular reflection region such as a highly polished region, the polarization level will be high (e.g., close to 100% polarization).

The analyzer 122 is disposed between the component 102 and the optical sensor 118. The analyzer 122 has a polarization axis oriented to limit, reduce, or block polarized light reflected from the component 102. The analyzer 122 may be configured to cancel a dominant polarization signal originating due to specular reflection (polarization preserving reflection). Thus, when the analyzer 122 is crossed with the polarizer 114, the specular reflected light does not pass through the analyzer 122. When polarized light interacts with the component 102, the polarized light is reflected back towards the optical sensor 118. Because the surface of the component 102 is highly polished, the polarization of reflected light is preserved. Reflection that preserves the polarization of incoming light may be referred to herein as specular reflection. However, when a defect is present on the component 102, the light is scattered and polarization is not preserved. Thus, by using the analyzer 122 to filter or limit polarized light, the optical sensor 118 can detect only defects or other features that result in non-polarization preserving reflection.

In some embodiments, the image acquisition apparatus 110 includes a magnifying element 120 associated with the optical sensor 118. The magnifying element 120 is a lens such as an objective lens. The magnifying element 120 is configured to collect light from the component 102 and focus it to create an image on the optical sensor 118 to help the optical sensor 118 to form a focused image.

In some embodiments, the image acquisition apparatus 110 includes a second light filter 121 that is configured to block, reflect, or absorb unwanted light to eliminate unwanted signatures in optical data (e.g., images) acquired by the inspection device 104. For example, the second light filter 121 can block, reflect, or absorb unwanted wavelengths of light. The second light filter 121 can be any suitable light filter including but not limited to a spectral filter, a band pass filter, a short pass, or long pass filter. In one example, in an event similar to FPI, the incident light may be ultraviolet (UV) light but the second light filter 121 is a green bandpass filter such that the light reaching to the optical sensor 118 is green. When a green bandpass filter is used to block all other spectral light, the signal detection at the optical sensor 118 may be improved in certain applications. The second light filter 121 may be selected based upon the response of the component 102 to incident light. For example, detection of defects or other characteristics of the component 102 can be improved if the second light filter 121, such as an optical (spectral) filter is present in the image acquisition apparatus 110 (e.g., on the camera side).

The positioning system 109 is configured to adjust the position of the component 102 relative to the illumination apparatus 108. The positioning system 109 can include any device that is operable to move the component 102 or portions thereof. The positioning system 109 can be configured to rotate the component 102, to move the component 102 linearly, or for a combination of linear and rotational movement of the component 102. In some examples, the positioning system 109 includes a movable platform, a turntable, a robotic arm, another device, or combinations of such devices to holds and, in some aspects, is capable of moving the component 102. In one implementation, the positioning system 109 includes one or more nest structures that include a recess (e.g., a cup) that is sized and shaped to receive the component 102 or a portion thereof. A vacuum or other suction source is operatively coupled to the nest structure to secure the component 102 or a portion thereof in place within the nest structure. In some aspects, the positioning system 109 includes a manipulator structure such as a robotic arm that is coupled to the nest structure to rotate otherwise move the component 102, for example, while the inspection device 104 acquires optical data, such as a set of images of the component 102.

The positioning system 109 may also include an encoder 140 that is configured to register a position of the component 102 relative to the inspection device 104. The encoder 140 can be any suitable sensing device that provides feedback regarding the position of the component 102 or portions thereof relative to the inspection device 104. The encoder 140 converts motion of the illumination apparatus 108 to an electrical signal that is communicated to the controller 106 to determine a position of the inspection device 104, for example, on the surface of the component 102. The controller 106 can then associate data from the positioning system 109 with the position of the inspection device 104 and assemble a set of inspection data that corresponds to a scan of the component 102. Examples of suitable encoders include motor encoders, rotary encoders, linear encoders, optical encoders, magnetic encoders, capacitive encoders, etc.

The controller 106 is operatively coupled to the inspection device 104 and the positioning system 109. The controller 106 is configured to operate the inspection device 104 and, in some embodiments, to operate the positioning system 109, to inspect the component 102. The controller 106 can be configured to operate one or more controllable devices of the illumination apparatus 108, such as, the light source 112. The controller 106 can also be configured to operate one or more controllable devices of the image acquisition apparatus 110, such as the optical sensor 118. The controller 106 may also be able to receive data from one or more of the light source 112 and the optical sensor 118. The controller 106 can also be configured to operate controllable devices of the positioning system 109. The positioning system 109 may include controllable devices such as motors, valves, vacuum pumps, actuators, etc. The positioning system 109 may also include a feedback system with one or more feedback sensors. The feedback sensors can include encoders (rotary, linear, etc.), resolvers, potentiometers, Hall effect sensors, or combinations thereof that provide information, for example, in real time, about the actual position, speed, and sometimes torque of the positioning system 109 or components of the positioning system 109. Details of the operation of the controller 106 are described further with reference to FIG. 4.

The controller 106 functions as a computing device to perform the functions and methods described herein. The controller 106 may include one or more processors 130, input/output (I/O) devices 132, and memory devices 124. The processors 130 may include any suitable processing device such as a microprocessor, microcontroller, integrated circuit, logic device, or other suitable processing device. The processors 130 may be used to execute or assist in executing the steps of the processes, methods, functionality, and techniques described herein, and to control various communications, decisions, programs, content, listings, services, interfaces, logging, reporting, etc. Further, the one or more processors 130 may access the memory devices 124, which can store instructions 128, code and the like that are executed by the processors 130 to implement intended functionality.

The memory devices 124 typically include one or more processor-readable or computer-readable media accessed by at least the processors 130 and may include volatile, nonvolatile media or combinations of volatile and nonvolatile media, such as RAM, ROM, EEPROM, flash memory, or other memory technology. Further, the memory devices 124 are shown as internal to the controller 106; however, the memory devices 124 can include internal memory, external memory or a combination of internal and external memory. Similarly, some or all of the memory devices 124 can be internal, external or a combination of internal and external memory of the processors 130. The memory devices 124 can be any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network. The memory devices 124 store data 126 such as code, software, executables, scripts, data, content, lists, programming, programs, log or history data, engine information, component information, and the like. While FIG. 1 illustrates the various components being coupled together via a bus, it is understood that the various components can be coupled to the controller 106 directly. The various components can also be coupled to one or more other components directly. The memory devices 124 store the operational code or set of instructions 128 that is executed by the controller 106 or the processor 130 to implement the functionality of the inspection system 100 or parts thereof. In some embodiments, the memory devices 124 store some or all of the data 126 needed to inspect or assess the component 102.

The I/O devices 132 may be any relevant port or combinations of ports, such as but not limited to USB, Ethernet, or other such ports. The I/O devices 132 may be configured to allow wired coupling, wireless communication, or a combination of wired and wireless coupling to external components. For example, the I/O devices 132 may provide wired communication or wireless communication (e.g., Wi-Fi, Bluetooth, cellular, RF, and/or other such wireless communication), and in some instances may include any suitable wired or wireless interfacing device, circuit or connecting device, such as but not limited to one or more transmitters, receivers, transceivers, or combination of two or more of such devices.

The controller 106 includes a user interface 134. The user interface 134 may be used to control one or more components of the inspection system 100. The user interface 134 may be used for user input display. The user interface 134 may also be used for output display. For example, the user interface 134 can include any known input devices, such as one or more buttons, knobs, selectors, switches, keys, touch input surfaces, audio input, displays, etc. Additionally, the user interface 134 can include one or more output display devices, such as lights, visual indicators, display screens, etc., to convey information to a user, such as but not limited to communication information, status information, order information, delivery information, notifications, errors, conditions, other such information, or combinations thereof. Similarly, the user interface 134 in some embodiments includes audio systems that can receive audio commands or requests verbally issued by a user. The audio systems may also output audio content, alerts, and the like.

A database 142 can include any data collected or used by the inspection system 100. In some examples, the database 142 includes data collected, generated, or otherwise received by the image acquisition apparatus 110. The database 142 can also include data collected, generated, or otherwise received via the controller 106. In one example, the database 142 includes optical data 144 collected, generated, or otherwise received from the optical sensor 118 of the image acquisition apparatus 110. In another example, the database 142 includes data, such as position data 146, recorded by the encoder 140. The database 142 need not be a single database but can include one or more databases. In some examples, the database 142 includes the optical data 144 that is indicative of the non-specular reflection of the light reflected from the surface of the component 102 and position data 146 that is indicative of a position on the component 102 at which such optical data 144 was acquired. In some examples, the database 142 is separate from the controller 106 and the inspection device 104. In other examples, the database 142 is part of the controller 106 or the inspection device 104.

One or more components of the inspection system 100 including the inspection device 104, the controller 106, the encoder 140, and the database(s) 142 can communicate information to or from one another over a network 150. The network 150 can be any suitable communication network such as, for example, LAN, WAN, Internet, cellular, Wi-Fi, and other such communication networks or combinations of two or more of such networks.

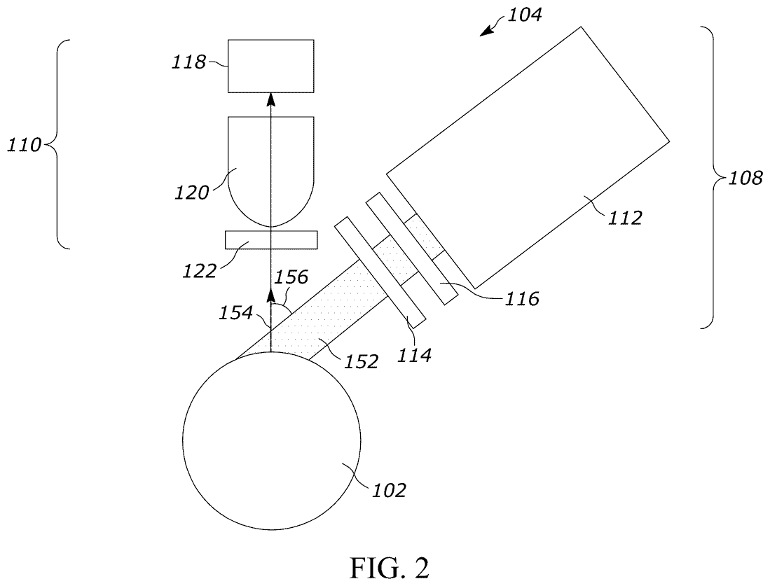

FIG. 2 shows an exemplary configuration of the inspection device 104 of FIG. 1, according to some embodiments. The inspection device 104 is shown inspecting a component 102. In the embodiment illustrated in FIG. 2, the component 102 is a bearing, for example, a ceramic bearing.

The illumination apparatus 108 is positioned to illuminate the surface of the component 102 with a beam of light 152. The illumination apparatus 108 includes the polarizer 114 and the iris 116. As illustrated, the light source 112 is positioned such that the beam of light 152 forms an incidence angle 156 of about 45 degrees. The incidence angle 156 is an angle between the beam of light and a line 154 that is perpendicular or normal to the surface of the component 102. It is contemplated that the incidence angle 156 can be between about 10 degrees and about 80 degrees, between about 20 degrees and about 70 degrees, between about 30 degrees and about 60 degrees, or, in some aspects, is between about 40 degrees and about 50 degrees.

As illustrated, the iris 116 and the polarizer 114 are positioned between the light source 112 and the component 102. The iris 116 is disposed closer to the light source 112 than the polarizer 114. However, in other configurations, the polarizer 114 can be disposed closer to the light source 112 than the iris 116.

The image acquisition apparatus 110 is positioned to detect light that is scattered or reflected from the component 102. The image acquisition apparatus 110 includes the optical sensor 118, the analyzer 122, and the magnifying element 120. The analyzer 122 is positioned between the optical sensor 118 and the component 102. The magnifying element 120 is positioned between the optical sensor 118 and the analyzer 122.

In operation, the illumination apparatus 108 uses the light source 112 to illuminate the component 102 with polarized light. The beam of light 152 from the light source 112 passes through the polarizer 114 to polarize the beam of light 152. The image acquisition apparatus 110 captures light reflected or scattered from the component 102. The light that is reflected or scattered from the component 102 passes through the analyzer 122. Polarized light that encounters the polished surface of the component 102 undergoes specular reflection and, thus, the polarization of the incident light is preserved. Polarized light that encounters a location of the component 102 that includes a defect such as a crack undergoes scattering. Scattering is a non-polarization preserving event. The analyzer 122 blocks polarized light (e.g., specular reflection), enabling the optical sensor 118 to observe non-polarization preserving scattering. Thus, the optical sensor 118 can detect regions of the component 102 where a defect or other feature is present. The optical sensor 118 captures optical data including images of the component 102. From the images, one or more defects or other features present on the component 102 can be detected or identified.

FIG. 3 shows an example defect 160 that can be detected using the inspection systems and devices described herein. The inspection system 100 of FIG. 1 can be used to detect the defect 160. In some examples, the inspection device 104 of FIG. 2 can be used to detect the defect 160. The defect 160 is present on the surface of the component 102 of FIG. 1. The defect 160 is a C-crack that is generally “C” shaped. The defect 160 has an opening 164 which is the space that exists between the separated surfaces of the crack. The defect 160 has a defect gap 162. As illustrated, the defect gap 162 is a width of the opening 164 at the widest point of the defect 160.

FIG. 4 is a diagram of example components of the controller 106 of FIG. 1. The components of the controller 106 may be implemented, for example, via the processor 130 (FIG. 1) executing instructions from memory 124 (FIG. 1). Alternatively, some or all of the components of controller 106 may be implemented via hard-wired circuitry. For example, components of controller 106 may correspond to an ASIC, FPGA, or another type of integrated circuit. As shown in FIG. 4, the controller 106 can include one or more of an inspection device controller 170, a position manager 172, a defect detection manager 174, or a beam steering manager 176. The components of the controller 106 may be configured to perform one or more of the functions or processes of the various managers shown in FIG. 4.

The inspection device controller 170 can control the operation of the inspection device 104 (FIG. 1). For example, the inspection device controller 170 can control operation of the light source 112 (FIG. 1) and activate the light source 112 to illuminate the component 102 (FIG. 1). In some approaches, the inspection device controller 170 controls or manages one or more parameters of the light source 112, such as the frequency, the bandwidth, the spectral wavelength or the polarization angle. In one example, the inspection device controller 170 adjusts the polarization angle of light emitted from the light source 112 by adjusting the polarizer 114 (FIG. 1). Further, the inspection device controller 170 may operate the iris 116 (FIG. 1) to adjust an amount of light that reaches the component and adjust the view of the optical sensor 118 (FIG. 1). Additionally, the inspection device controller 170 may control the optical sensor 118 (FIG. 1). In some examples, the inspection device controller 170 operates the optical sensor 118 to acquire images or other optical data of the component 102 during an inspection.

The position manager 172 can manage the location of the inspection device 104 on the surface of the component 102. For example, the position manager 172 can control operation of one of more devices in the positioning system 109 (FIG. 1). In some approaches, the position manager 172 coordinates with the inspection device 104 to perform a scan of the component 102. The position manager 172 may control the positioning system 109 to rotate or otherwise move the component 102 to perform a scan or inspection of an entire surface or an area of the surface of the component 102. The position manager 172 can also keep track of a current location of the inspection device 104, for example, based on data from the encoder 140 (FIG. 1). In some embodiments, the position manager 172 is in communication with the inspection device controller 170. For example, the position manager 172 may communicate with the inspection device controller 170 to collect a series of images using the inspection device 104 as the position manager 172 moves the inspection device controller 170 along the surface of the component 102.

The defect detection manager 174 can manage the identification of defects or other features of the component 102 based on optical data acquired by the inspection device 104. In some embodiments, the defect detection manager 174 uses a machine learning algorithm to identify defects based on the optical data (e.g., images) acquired using the inspection device 104. The defect machine learning algorithm can be trained on a plurality of historical images of known defects, with the plurality of historical images tagged with known historical defects. The plurality of historical images are tagged with defect identifiers. Thus, the defect machine learning algorithm can receive images acquired from an inspection as input and output a defect identifier associated with the image as output. Further, in some embodiments, the defect detection manager 174 determines a component status based on optical data acquired by the inspection device 104. For example, the component status can indicate whether the component passes or fails an inspection. In one approach, the defect detection manager 174 can assign a component status using a status machine learning algorithm. The status machine learning algorithm can be trained on a plurality of historical images tagged with a pass or fail identifier. The status machine learning algorithm can then receive an inspection image as input and output a pass or fail identifier for the image as output.

The beam steering manager 176 can manage the path or angle of incident light from the light source 112. The beam steering manager 176 can adjust or rotate the mirror 119 (FIG. 1) of the beam steering assembly 117 (FIG. 1), for example, via an actuator. The beam steering manager 176 may adjust the mirror 119 (FIG. 1) based on optical data such as images from the inspection device 104 to control the incident light on the component 102.

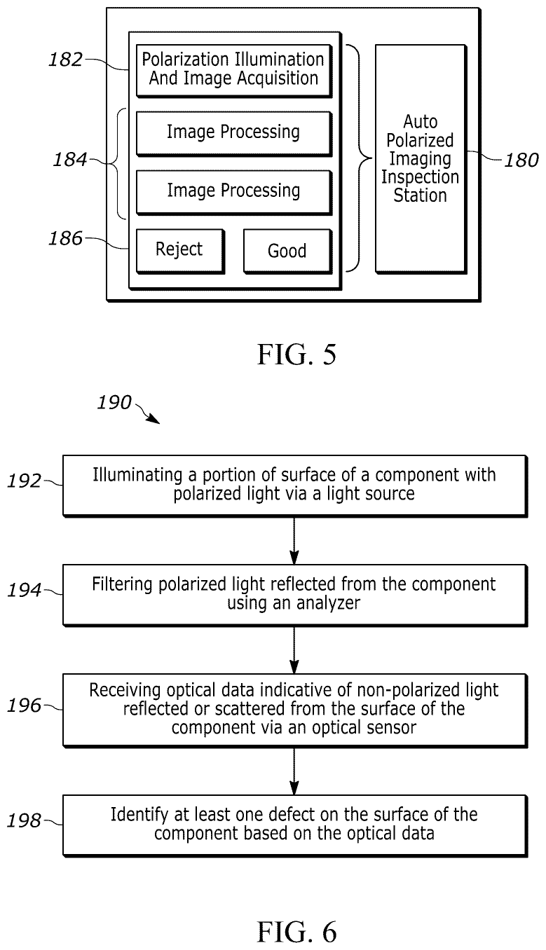

FIG. 5 is a schematic diagram of a method 180 that can be performed using an automatic polarized imaging inspection station 182. The automatic polarized imaging inspection station 182 may be equipped with the inspection system 100 of FIG. 1 or portions thereof. In some examples, the automatic polarized imaging inspection station 182 is equipped with the inspection device 104, the positioning system 109, and the controller 106 of FIG. 1. The method 180 can be used to inspect the component 102 of FIG. 1.

At 184, the automatic polarized imaging inspection station 182 illuminates the component with polarized light using the inspection device 104. The automatic polarized imaging inspection station 182 then acquires images of the component 102 with the inspection device 104.

At 186, the controller 106 performs image processing. Image processing may involve one or more of background subtraction, feature enhancement, or automatic crack detection. Background subtraction involves subtracting a background image from a current image to identify the at least one defect. Feature enhancement can include any suitable imaging processing techniques for enhancing target features (e.g., defects) enhance visibility in images acquired via the inspection device 104. Automatic crack detection can be performed using machine learning as described with reference to the defect detection manager 174 of FIG. 4.

At 188, the controller 106 determines whether to reject the component 102 (FIG. 1) or whether the component 102 is good and passes the inspection. The controller 106 may determine whether the component 102 should be rejected, for example, based on defects identified during image processing.

FIG. 6 includes a flow diagram of a method 190 of inspecting a component for defects using polarized light. The method 190 or portions thereof can be performed using the inspection system 100 described with reference to FIG. 1. For example, the controller 106 of FIG. 1 may be configured to perform the method 190 or portions thereof. The method 190 can be used to inspect the component 102 of FIG. 1.

At 192, a portion of the surface of a component is illuminated with polarized light via a light source. In some examples, the light source 112 and the polarizer 114 (FIG. 1) of the illumination apparatus 108 (FIG. 1) are used to illuminate the component 102 with polarized light. The iris 116 (FIG. 1) of the illumination apparatus 108 can be used to adjust an area of the component 102 that is illuminated.

At 194, polarized light reflected from the surface of the component is filtered using an analyzer. The analyzer may be configured to limit, reduce, or block polarized light so that only non-polarized light is received by an optical sensor. In this manner, light that is reflected via specular reflection is blocked and light that is scattered via non-specular reflection is allowed to pass through to the optical sensor. In some examples, the analyzer 122 (FIG. 1) of the image acquisition apparatus 110 (FIG. 1) is used to filter polarized light.

At 196, optical data that is indicative of non-polarized light that is reflected or scattered from the surface of the component is received via an optical sensor. Thus, the optical data (e.g., images) capture data that is indicative of light that is scattered via non-specular reflection. In some examples, the optical sensor 118 (FIG. 1) of the image acquisition apparatus 110 is used to acquire optical data such as images of the component 102. The optical data can be transmitted to the controller 106.

At 198, at least one defect is identified on the surface of the component based on the optical data. In some examples, the controller 106 is configured to identify at least one defect on the surface of the component 102 based on the optical data. The controller 106 can include the defect detection manager 174 to identify defects based on the optical data. Though, it is contemplated that defect identification may also be performed manually, for example, by the evaluation of images acquired using the inspection device 104 (FIG. 1).

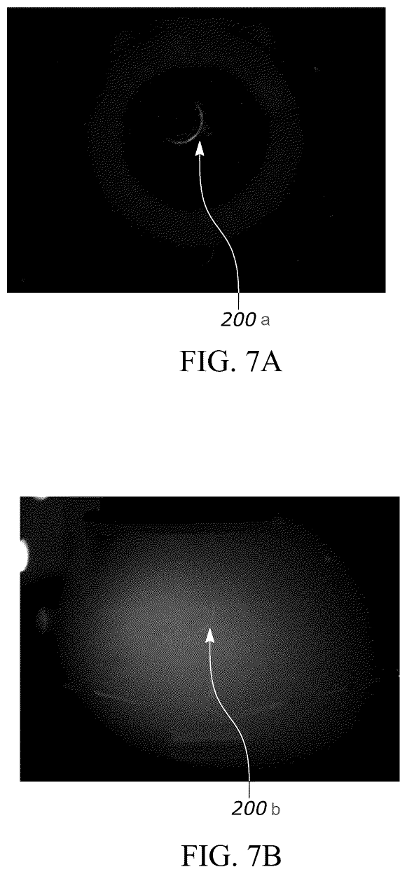

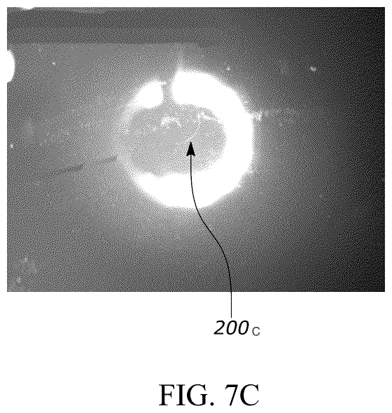

FIGS. 7A-7C are images of an exemplary component that were captured using various inspection techniques. The component was a ceramic bearing.

FIG. 7A is an image of a defect 200a of a component. The defect 200a is a C-crack. The image of FIG. 7A was acquired using fluorescent penetrant inspection. The FPI image provides clear contrast when the ceramic bearing is coated with the fluorescent pigment and exposed to ultraviolet light. The light emitted from the fluorescent pigment is absorbed within the C-crack and illuminates the C-crack in the resulting image.

FIG. 7B is an image of a defect 200b that was acquired using the devices and techniques described herein. The defect 200b is the same defect as the defect 200a of FIG. 7A. That is, the image of FIG. 7B was acquired using the inspection device 104 of FIGS. 1 and 2. As shown, the defect 200b is visible in the polarized light image.

FIG. 7C is an image of a defect 200c that was acquired using white light imaging. The defect 200c is the same defect as the defect 200a of FIG. 7A and the defect 200B of FIG. 7B. Unpolarized white light was used to illuminate the component in FIG. 7C. As shown, the defect 200c is visible but has a lower signal to noise ratio (SNR) for detecting the defect 200c as compared with the polarized light image of FIG. 7B.

Further aspects of the disclosure are provided by the subject matter of the following clauses:

An inspection system comprising: a light source arranged to illuminate a component with light; a polarizer disposed between the light source and the component to polarize the light emitted by the light source; an optical sensor arranged to detect light reflected or scattered from the component; an analyzer disposed between the component and the optical sensor, the analyzer having a polarization axis oriented to limit polarized light reflected from the component to reach the optical sensor; and a controller in operative communication with the optical sensor, the controller configured to: receive optical data indicative of non-polarized light reflected or scattered from the component from the optical sensor; and identify at least one defect on the component based on the optical data.

The inspection system of any preceding clause, wherein the component is made of a ceramic material.

The inspection system of any preceding clause, wherein the component is a ceramic bearing.

The inspection system of any preceding clause, wherein the at least one defect is a crack.

The inspection system of any preceding clause, wherein the light source includes at least one of a light emitting diode (LED), a light bulb, or a laser.

The inspection system of any preceding clause, wherein the light emitted by the light source is a single spectral light source.

The inspection system of any preceding clause, wherein the light emitted by the light source is multispectral light.

The inspection system of any preceding clause, wherein the optical sensor includes at least one of an optical camera or a polarization sensor.

The inspection system of any preceding clause wherein the inspection system further comprises a hyper spectral sensor to detect at least one of a change in bandwidth or a change in wavelength of the light.

The inspection system of any preceding clause, further comprising: an iris disposed between the polarizer and the light source, and wherein the iris comprises an adjustable aperture to control an amount of light passing through the polarizer.

The inspection system of any preceding clause, further comprising: a magnifying element disposed between the analyzer and the optical sensor, wherein the analyzer is disposed between the magnifying element and the optical sensor.

The inspection system of any preceding clause, wherein the magnifying element is an objective lens.

The inspection system of any preceding clause, wherein a wavelength of light emitted from the light source is less than or the same size as a defect gap associated with a defect to be detected on the component.

The inspection system of any preceding clause, wherein the controller is further configured to determine whether the component passes or fails an inspection based on the optical data.

The inspection system of any preceding clause, wherein the controller is operatively coupled to the light source and is configured to adjust at least one of a frequency or bandwidth of the light emitted from the light source.

The inspection system of any preceding clause, wherein the controller is further configured to perform background subtraction to subtract a background image from a current image to identify the at least one defect.

The inspection system of any preceding clause, wherein the controller is further configured to enhance visibility of the at least one defect via feature enhancement.

The inspection system of any preceding clause, wherein the controller is further configured to automatically detect at least one defect via a machine learning algorithm.

The inspection system of any preceding clause, wherein the machine learning algorithm is trained on known historical defects for a plurality of historical components.

The inspection system of any preceding clause, further comprising: a first light filter disposed between the light source and the component, wherein the first light filter is at least one of a spectral filter, a band path filter, or a polarization filter.

The inspection system of any preceding clause, further comprising: a second light filter disposed between the light source and the component, wherein the second light filter is at least one of a spectral filter, a band path filter, or a polarization filter.

The inspection system of any preceding clause, wherein the light source is positioned such that the beam of light forms an incidence angle of between about 20 degrees and about 70 degrees, wherein the incidence angle is an angle between the beam of light and a line that is perpendicular to the surface of the component.

The inspection system of any preceding clause, wherein the incidence angle is between about 30 degrees and about 60 degrees.

The inspection system of any preceding clause, wherein the incidence angle is between about 40 degrees and about 50 degrees.

An inspection system comprising: an illumination apparatus including a light source positioned to illuminate a component with polarized light; an image acquisition apparatus including an optical sensor positioned to detect light reflected from the component, the image acquisition apparatus including an analyzer having a polarization axis oriented to limit polarized light reflected from the component via specular reflection; and a controller in communication with the image acquisition apparatus, the controller configured to: receive optical data indicative of non-polarized light reflected or scattered from the component from the optical sensor; and identify at least one defect on the component based on the optical data.

The inspection system of any preceding clause, further comprising a positioning system that is coupled to the controller, and wherein the controller is configured to adjust a position or control a motion of the component via the positioning system.

The inspection system of any preceding clause, wherein the positioning system includes at least one of a robotic arm, a turntable, or a nest structure and suction source.

The inspection system of any preceding clause, wherein the positioning system further comprises an encoder to register a position of the illumination apparatus relative to the component.

The inspection system of any preceding clause, wherein the illumination apparatus further includes a beam steering assembly with a mirror to redirect light emitted from the light source.

The inspection system of any preceding clause, wherein the beam steering assembly includes a galvanometer actuator to adjust a position of the mirror.

The inspection system of any preceding clause, wherein the controller is configured to adjust the mirror via the galvanometer actuator.

The inspection system of any preceding clause, wherein the controller includes an inspection device controller configured to control operation of the light source.

The inspection system of any preceding clause, wherein the inspection device controller is configured to manage one or more parameters of the light source.

The inspection system of any preceding clause, wherein the one or more parameters of the light source include at least one of a frequency, a bandwidth, a spectral wavelength, or a polarization angle.

The inspection system of any preceding clause, wherein the inspection device controller is further configured to operate an iris disposed between the light source and the component.

The inspection system of any preceding clause, wherein the inspection device controller is further configured to operate the optical sensor to acquire images of the component.

The inspection system of any preceding clause, wherein the controller includes a position manager configured to manage the location of the inspection device on the surface of the component.

The inspection system of any preceding clause, wherein the position manager is configured to operation of one of more devices in the positioning system.

The inspection system of any preceding clause, wherein the position manager is configured to control the positioning system to move the component to perform a scan of an area of the surface of the component.

The inspection system of any preceding clause, wherein the position manager is configured to track a current location of the inspection device based on data from the encoder.

The inspection system of any preceding clause, wherein the controller includes a defect detection manager configured to identify defects or features of the component based on the optical data.

The inspection system of any preceding clause, wherein the defect detection manager includes a machine learning algorithm to identify defects based on the optical data, the machine learning algorithm trained on a plurality of historical images of known defects, with the plurality of historical images tagged with known historical defects.

The inspection system of any preceding clause, wherein the defect detection manager is configured to determine a component status based on optical data acquired by the inspection device.

The inspection system of any preceding clause, wherein the controller includes a beam steering manager configured to manage a path or an angle of incident light from the light source.

The inspection system of any preceding clause, wherein the beam steering manager is configured to adjust the mirror of the beam steering assembly.

A method for inspecting a component, the method comprising: illuminating a portion of surface of a component with polarized light via a light source; receiving optical data indicative of non-specular reflection of the polarized light reflected from the surface of the component via an optical sensor; and identifying at least one defect on the surface of the component based on the optical data.

The method of any preceding clause, wherein identifying at least one defect comprises identifying at least one defect via a machine learning algorithm trained on historical images of known defects tagged with known historical defects for a plurality of historical components.

The method of any preceding clause, further comprising: moving at least one of the component or the light source via a positioning system to scan of an area of the surface of the component.

The method of any preceding clause, further comprising: analyzing the optical data via at least one of background subtraction or feature enhancement.

A method for inspecting a component, the method comprising: illuminating the component with polarized light via an automatic polarized imaging inspection station; acquiring images of the component via the automatic polarized imaging inspection station; performing imaging processing via a controller associated with the automatic polarized imaging inspection station; and determining whether to reject the component or whether the component passes inspection based on the image processing.

The method of any preceding clause, wherein the image processing includes one or more of background subtraction, feature enhancement, or automatic crack detection.

The method of any preceding clause, wherein automatic crack detection is performed using a machine learning algorithm trained on a plurality of historical images of known defects, with the plurality of historical images tagged with known historical defects.

The method of any preceding clause, wherein the polarized imaging inspection station comprises an inspection device with a light source arranged to illuminate the component, a polarizer disposed between the light source and the component, and an optical sensor arranged to detect light reflected or scattered from the component, and an analyzer having a polarization axis oriented to limit polarized light reflected from the component to the optical sensor.

The method of any preceding clause, wherein illuminating the component includes illuminating the component with polarized light form the light source of the inspection device.

The method of any preceding clause, wherein acquiring images of the component includes acquiring images via the optical sensor of the inspection device.

The method of any preceding clause, wherein the controller is configured to: receive optical data indicative of non-polarized light reflected or scattered from the component from the optical sensor; and identify at least one defect on the component based on the optical data.

The method of any preceding clause, wherein the automatic polarized imaging inspection station includes the inspection system of any preceding clause.

What is claimed is:

1. An inspection system comprising:
a light source arranged to illuminate a component with light;
a polarizer disposed between the light source and the component to polarize the light emitted by the light source;
an optical sensor arranged to detect light reflected or scattered from the component;
an analyzer disposed between the component and the optical sensor, the analyzer having a polarization axis oriented to limit polarized light reflected from the component to reach the optical sensor; and
a controller in communication with the optical sensor, the controller configured to:
receive optical data indicative of non-polarized light reflected or scattered from the component from the optical sensor; and
identify at least one defect on the component based on the optical data.

2. The inspection system of claim 1, wherein the component is made of a ceramic material.

3. The inspection system of claim 1, wherein the light emitted by the light source is multispectral light.

4. The inspection system of claim 1, wherein the inspection system further comprises a hyper spectral sensor to detect at least one of a change in bandwidth or a change in wavelength of the light.

5. The inspection system of claim 1, further comprising:
an iris disposed between the polarizer and the light source, and wherein the iris comprises an adjustable aperture to control an amount of light passing through the polarizer.

6. The inspection system of claim 1, wherein a wavelength of light emitted from the light source is less than or the same size as a defect gap associated with a defect to be detected on the component.

7. The inspection system of claim 1, wherein the controller is further configured to determine whether the component passes or fails an inspection based on the optical data.

8. The inspection system of claim 1, wherein the controller is further configured to perform background subtraction to subtract a background image from a current image to identify the at least one defect.

9. The inspection system of claim 1, wherein the controller is further configured to enhance visibility of the at least one defect via feature enhancement.

10. The inspection system of claim 1, wherein the controller is further configured to automatically detect at least one defect via a machine learning algorithm.

11. The inspection system of claim 10, wherein the machine learning algorithm is trained on historical images of known defects tagged with known historical defects for a plurality of historical components.

12. An inspection system comprising:
an illumination apparatus including a light source positioned to illuminate a component with polarized light;
an image acquisition apparatus including an optical sensor positioned to detect light reflected from the component, the image acquisition apparatus including an analyzer having a polarization axis oriented to limit polarized light reflected from the component via specular reflection; and
a controller in communication with the image acquisition apparatus, the controller configured to:
receive optical data indicative of non-polarized light reflected or scattered from the component from the optical sensor; and
identify at least one defect on the component based on the optical data.

13. The inspection system of claim 12, further comprising a positioning system that is coupled to the controller, and wherein the controller is configured to adjust a position or control a motion of the component via the positioning system.

14. The inspection system of claim 13, wherein the positioning system includes at least one of a robotic arm, a turntable, or a nest structure and suction source.

15. The inspection system of claim 13, wherein the positioning system further comprises an encoder to register a position of the illumination apparatus relative to the component.

16. The inspection system of claim 12, wherein the illumination apparatus further includes a beam steering assembly including a mirror to redirect light emitted from the light source.

17. The inspection system of claim 16, wherein the beam steering assembly includes a galvanometer actuator to adjust a position of the mirror.

18. A method for inspecting a component, the method comprising:
illuminating a portion of surface of a component with polarized light via a light source;
receiving optical data indicative of non-specular reflection of the polarized light reflected from the surface of the component via an optical sensor; and
identifying at least one defect on the surface of the component based on the optical data.

19. The method of claim 18, wherein identifying at least one defect comprises identifying at least one defect via a machine learning algorithm trained on known historical defects for a plurality of historical components.

20. The method of claim 18, further comprising:
analyzing the optical data via at least one of background subtraction or feature enhancement.
